(19) United States
(12) Patent Application Publication
(10) Pub. No.: US 2015/0013093 A1
(43) Pub. Date: Jan. 15, 2015

(54) WIPER COUPLER ADAPTOR AND WIPER ASSEMBLY INCORPORATING SAME

(71) Applicant: TRICO PRODUCTS CORPORATION, Rochester Hills, MI (US)

(72) Inventors: Mitica Polocoser, Wayne, MI (US); Kyle Moll, Oxford, MI (US); C. Joseph Thielen, Shelby Township, MI (US)

(21) Appl. No.: 13/940,485

(22) Filed: Jul. 12, 2013

(51) Int. Cl. B60S 1/38

(52) U.S. Cl. CPC B60S 1/3849
USPC 15/250.32

(57) ABSTRACT

A wiper coupler adaptor for releasably attaching a wiper assembly to a wiper arm includes a pair of sidewalls, each having recessed sections adapted to operatively engage rails of an attachment member of a wiper arm. An elevated platform is disposed between the sidewalls and a deck to define an aperture adapted to receive a portion of a bent tab of the attachment member, and a snap bridge disposed within the aperture that is adapted to receive a portion of the bent tab of the attachment member to prevent undesired release of the wiper coupler adaptor from the attachment member. A rib is disposed within the aperture and extends from at least one of the sidewalls to prevent the snap bridge from breakage by the bent tab of the attachment member if mis-assembled.

### BACKGROUND OF THE INVENTION

1. Field of the Invention

The present invention relates generally to wiper assemblies and, more specifically, to a wiper coupler adaptor and wiper assembly incorporating same for use in connecting the wiper assembly to a wiper arm of a vehicle.

2. Description of the Related Art

Conventional wiper assemblies known in the related art include some type of wiper assembly mounted to a wiper arm which, in turn, is mounted adjacent a windshield and pivotally driven to impart reciprocating motion to the wiper assembly across the windshield. The wiper assembly includes a rubber wiping element that contacts the windshield across the surface to be wiped. Generally, the wiper assembly may be classified into one of two categories commonly referred to as “tournament-style” wiper assemblies and “beam-blade” wiper assemblies.

Beam-blade style wiper assemblies include a single elongated, homogeneous strip forming a spring backbone. The backbone is operatively coupled to the wiper arm by a fixed connecting formation at a central position. In a beam-blade style wiper assembly, the reciprocally driven wiper arm applies a downward force and moves the wiper assembly across the surface to be wiped, which is generally the windshield. The backbone is curved along a single plane which is the same plane of curvature as that defined by the windshield. The wiping element is fixedly secured to the backbone. One example of a beam-blade style wiper assembly can be found in U.S. Pat. No. 6,675,433 issued to Stewart, et al., on Jan. 13, 2004 and assigned to the Assignee of the present invention, Trico Products Corporation.

While beam blade-style wiper assemblies are limited for use with a particular style of wiper arm, the coupler of a beam blade-style wiper assembly is usually designed solely for use with a single type of wiper arm style. A typical adaptor connection, side pinch with a lateral pull or over center, connects the coupler to the attachment member of the wiper arm and can be disassembled during wipe. However, if a bent tab of the attachment member is misassembled to the adaptor, the mis-assembly force could break off the snap bridge, making the adaptor un-functional for assembly. As a result, it is desirable to provide a coupler adaptor that protects the snap bridge from misassembly and prevents breakage of the snap bridge due to a mis-assembly force.

Accordingly, there is a need in the art for a wiper coupler adaptor that operatively attaches a beam blade-style wiper assembly to a wiper arm. In addition, there is a need in the art for a wiper coupler adaptor that prevents breakage due to a mis-assembly force with an attachment member of the wiper arm for a beam blade-style wiper assembly.

### SUMMARY OF THE INVENTION

The present invention overcomes many limitations and disadvantages in the related art in a wiper coupler adaptor, as well as a wiper assembly, for use in connection with an attachment member of a wiper arm. The wiper coupler adaptor includes a pair of sidewalls extending longitudinally and each including a post that extends laterally toward the other and adapted to operatively engage a wiper assembly. The sidewalls include recessed sections adapted to operatively engage rails of an attachment member of a wiper arm. The wiper coupler adaptor also includes a deck disposed between the sidewalls to define a rest that is adapted to operatively receive a track between the rails of the attachment member. The wiper coupler adaptor includes an elevated platform disposed between the sidewalls that cooperates with the sidewalls and the deck to define an aperture adapted to receive a portion of a bent tab of the attachment member and a snap bridge disposed within the aperture and depending from the elevated platform and including a cantilevered body and a head disposed at a terminal end of the cantilevered body. The head includes a lip depending therefrom that is adapted to receive a portion of the bent tab of the attachment member to prevent undesired rotational release of the wiper coupler adaptor from the attachment member. The wiper coupler further includes a rib disposed within the aperture and extending from at least one of the sidewalls to prevent the snap bridge from breakage by the bent tab of the attachment member if mis-assembled.

Thus, one advantage of the present invention is that a new wiper coupler adaptor is provided to operatively engage a beam blade-style wiper assembly to a wiper arm. Another advantage of the present invention is that the wiper coupler adaptor provides a rib to protect a snap bridge from breakage due to mis-assembly with the bent tab of the attachment member of the wiper arm. Yet another advantage of the present invention is that the wiper coupler adaptor has a rib that protects the adaptor from improper assembly with the attachment member.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of a front of a vehicle having a pair of wiper assemblies pivotally mounted for reciprocal movement across a windshield of the vehicle.

FIG. 2 is an enlarged perspective view of one of the wiper assemblies of FIG. 1.

FIG. 3 is a perspective view of an attachment member of a wiper arm for attachment to the wiper assembly of FIG. 2.

FIG. 4 is a fragmentary elevational view of the wiper assembly of FIG. 2.

FIG. 5 is a top perspective view of a wiper coupler adaptor, according to the present invention, for connecting the wiper assembly of FIG. 2 to the attachment member of the wiper arm of FIG. 3.

FIG. 6 is another top perspective view of the wiper coupler adaptor of FIG. 5 in accordance with the present invention.

FIG. 7 is a bottom perspective view of the wiper coupler adaptor of FIG. 5 in accordance with the present invention.

FIG. 8 is another bottom perspective view of the wiper coupler adaptor of FIG. 5 in accordance with the present invention.

FIG. 9 is a top plan view of the wiper coupler adaptor of FIG. 5 in accordance with the present invention.

FIG. 10 is a fragmentary perspective view of the wiper coupler adaptor of FIG. 5 in accordance with the present invention.

FIG. 11 is a fragmentary perspective view of the wiper coupler adaptor of FIG. 5 operatively engaging a wiper coupler of the wiper assembly and the attachment member of the wiper arm of FIG. 2.

FIG. 12 is a perspective view of the wiper coupler adaptor of FIG. 5 operatively engaging a wiper coupler of the wiper assembly and the attachment member of the wiper arm of FIG. 2 in a first position.

FIG. 13 is a perspective view of the wiper coupler adaptor of FIG. 5 operatively engaging a wiper coupler of the wiper assembly and the attachment member of the wiper arm of FIG. 2 in a second position.

### DETAILED DESCRIPTION OF THE PREFERRED EMBODIMENT(S)

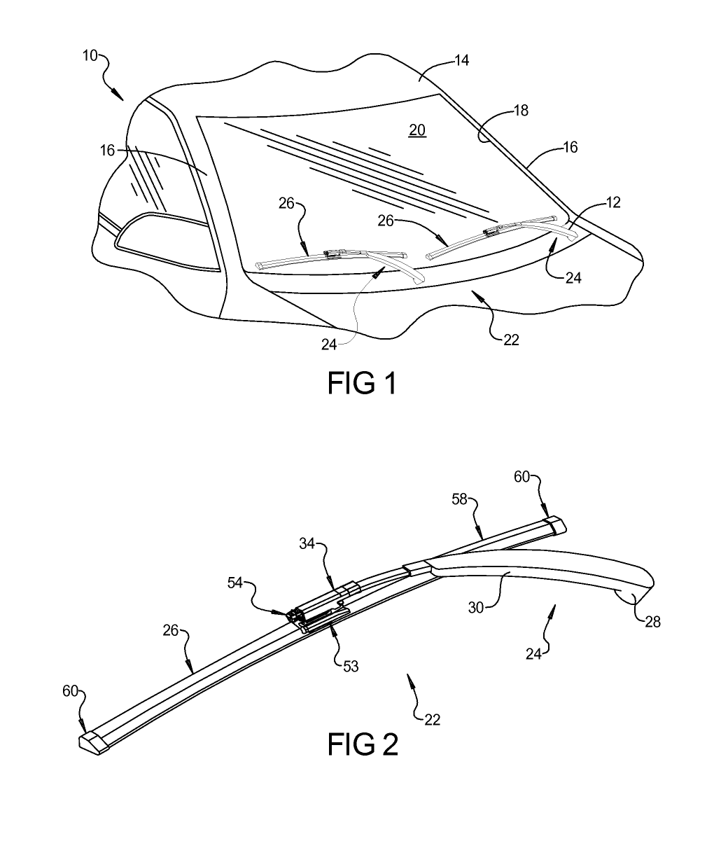

Referring now to the figures, where like numerals are used to designate like structure, a portion of a vehicle is schematically illustrated at 10 in FIG. 1. The vehicle 10 includes a cowl 12, a roof 14, and a pair of laterally spaced front or “A” pillars 16 extending between the roof 14 and the cowl 12. The A-pillars 16, roof 14, and cowl 12 cooperate to define a generally rectangular opening 18 in which is supported a curved or “swept back” glass windshield 20.

A wiper system is generally indicated at 22 in FIG. 1 and is employed to clean the windshield 20. The wiper system 22 includes a wiper arm, generally indicated at 24, and a wiper assembly, generally indicated at 26. Those having ordinary skill in the art will appreciate that a wiper system 22 may include more than one wiper arm 24 and more than one wiper assembly 26. By way of example and as indicated in FIG. 1, a wiper system 22 may include a pair of wiper arms 24 and wiper assemblies 26, which correspond to the driver and passenger side of the vehicle 10.

Referring to FIG. 2, the wiper arm 24 includes a pivot end 28 operatively attached to an electrical motor (not shown) to move the wiper arm 24 across the surface to be wiped in an oscillating manner. The wiper arm 24 further includes an elongate body 30 that extends outward from the pivot end 28 and an attachment member 34, described in greater detail below, at a free end of the elongate body 30. The elongate body 30 includes a predetermined length to direct the wiper assembly 26 across the appropriate surface area. Accordingly, it will be appreciated that the predetermined length of the elongate body 30 will vary depending on the surface area to be wiped. Furthermore, those having ordinary skill in the art will appreciate that the elongate body 30 may be jointed for movement away from the surface to be wiped in order to facilitate replacement of the wiper assembly 26 when worn or to perform other maintenance or repair to the wiper system 22 or adjacent area of the vehicle 10. In addition to these elements, the wiper arm 24 may further include a biasing member (not shown), such as a spring, to provide a biasing force that facilitates contact between the wiper assembly 26 and the windshield 20 of the vehicle 10.

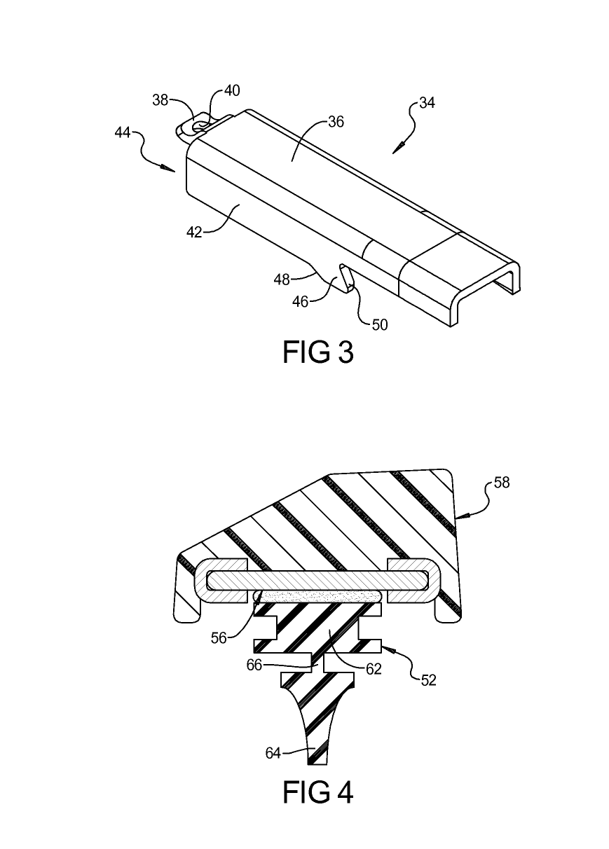

Referring to FIG. 3, the wiper arm 24 further includes an attachment member, generally indicated at 34, disposed at or adjacent to the end of the elongate body 30, opposite the pivot end 28. The attachment member 34 is adapted to operatively engage the wiper assembly 26, as will be described in greater detail below. The attachment member 34 includes a base 36 and bent tab 38 extending longitudinally outward from the base 36 and having an aperture 40 extending therethrough. The attachment member 34 further includes a pair of rails 42 depending from the base 36 and aligned with respect to each other. The base 36 and rails 42 cooperate to define a track, generally indicated at 44, to operatively receive a portion of the wiper assembly 26, as will be described in greater detail below. Each of the rails 42 includes a guide 46 that extends linearly downward relative to the rails 42. Each of the guides 46 includes a leading edge 48 and a trailing edge 50, the function of each will be described in greater detail below. The trailing edge 50 is angled relative to the base 36, such that the leading edge 48 and the trailing edge 50 form an acute angle. However, those having ordinary skill in the art will appreciate that trailing edge 50 may also extend substantially perpendicular relative to the base 36 without departing from the scope of the invention.

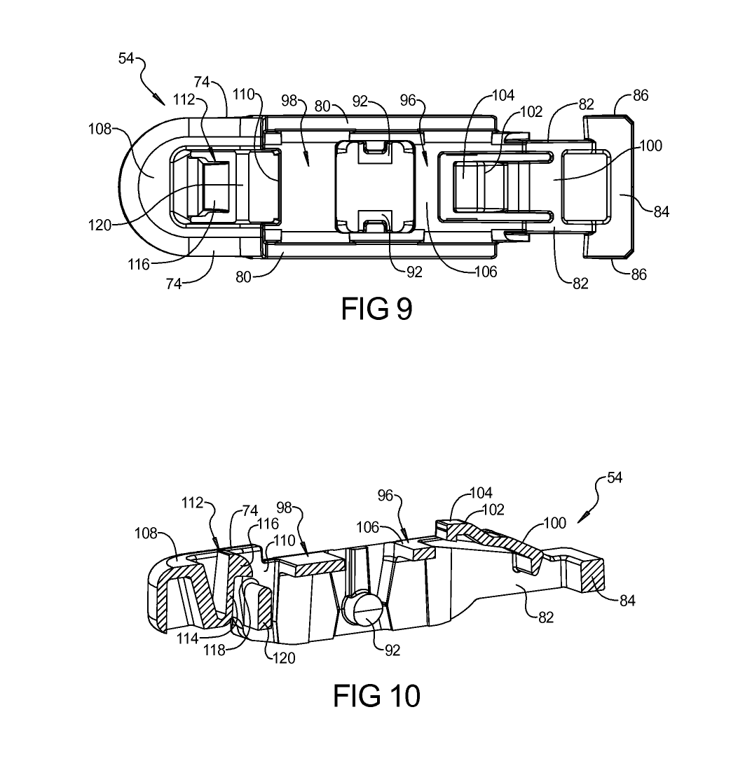

The wiper arm 24 having the attachment member 34 that includes the structure described above is commonly employed for connection with a beam blade-style wiper assembly 26 and does not form part of this invention. Rather, those having ordinary skill in the art will appreciate that the present invention is a wiper coupler adaptor and beam blade-style wiper assembly, described in greater detail below, that operatively attaches to the attachment member 34 (exemplarily illustrated in FIGS. 2, 3, 9, 10 and 11). It should also be appreciated that the wiper coupler adaptor of the present invention may be employed for attachment to a tournament-style wiper assembly (not shown).

Referring to FIGS. 2 and 4, the wiper assembly 26 includes a wiping element, generally indicated at 52, that is adapted to contact the surface of the vehicle 10 to be wiped, in this representative example, the windshield 20. In addition, the wiper assembly 26 also includes a wiper coupler, generally indicated at 53, connected to a beam 56 to be described of the wiper assembly 26 and a wiper coupler adaptor, generally indicated at 54, that acts to interconnect the wiper coupler 53 of the wiper assembly 26 and the attachment member 34 of the wiper arm 24. The wiper assembly 26 also includes at least one elongated beam, generally indicated at 56, that defines a longitudinal axis and that acts to support the wiping element 52. In the representative embodiment illustrated herein, the beam 56 is generally rectangular in shape and extends longitudinally. The wiping element 52 is attached to a bottom surface of the beam 56 by a suitable mechanism such as an adhesive. However, those having ordinary skill in the art will appreciate from the description that follows that the beam 56 may be either monolithic or defined by a pair of rails. The wiper assembly 26 may also include an airfoil assembly, generally indicated at 58, and a pair of end caps, generally indicated at 60, both according to one embodiment of the present invention. It should be appreciated that the attachment member 34 is operatively attached to the beam blade-style wiper assembly 26 via the wiper coupler adaptor 54.

As illustrated in FIG. 4, the wiping element 52 includes an upper section 62 and a lower section 64 that are partitioned by a longitudinally extending bridge portion 66. The bridge portion 66 provides flexibility between the upper section 62 and lower section 64 during operational movement of the wiper assembly 26 across the surface to be wiped. The wiping element 52 has a predetermined length corresponding to particular application and is often manufactured through an extrusion process, which enables the length of the wiping element 52 to be easily adjusted without a substantial increase to manufacturing expense. Furthermore, while the wiping element 52 of the present invention is constructed from a flexible rubber, those having ordinary skill in the art will appreciate that it may be constructed from any flexible material such as silicone or other polymer without departing from the scope of the present invention.

The beam 56 may be constructed from a resiliently flexible material, such as spring steel or a polymer, and is adapted to apply force from an intermediate position between first and second longitudinal ends to the first and second longitudinal ends. More specifically, the beam 56 receives force from the spring-loaded wiper arm 24 at an intermediate position and distributes this force across the span of the beam 56 toward the first and second longitudinal ends. To that end, the beam 56 may be curved longitudinally with a predetermined radius of curvature. This predetermined radius of curvature is sometimes referred to in the related art as a “free form” radius of curvature. Accordingly, the curvature of the beam 56 may be symmetrical or asymmetrical depending on the force requirements and the contour of the windshield 20. The flexible, free form, pre-curved beam 56 straightens out when the wiper arm 24 applies a force thereto to flatten the beam 56 and directs the wiping element 52 to contact the windshield 20. Thus, the elongated beam 56 includes a free-form curvature that ensures force distribution on windshields having various curvatures that effects proper wrapping about the windshield 20.

As illustrated throughout the figures, the beam 56 has a substantially constant width and may have a constant thickness throughout the length between the first and second longitudinal. The constant width and thickness are adapted to provide high lateral and torsional stiffness to avoid lateral and torsional deflection, which causes the wiping element 52 to stick/slip (“chatter”) on the windshield 20 during operation. Thus, the cross-section of the beam 56 has a generally rectangular outer profile that makes the elongated beam 56 easier to manufacture. More specifically, where the beam 56 is constructed from metal, such as spring steel, the tools and machinery used to manufacture the beam 56 are less complicated than that required to manufacture having varying widths and/or thicknesses. Furthermore, where the beam 56 is constructed from a polymer, such as a thermoplastic elastomer, the tools and extrusion process machinery are also less complicated than those employed to manufacture beams having varying widths and/or thicknesses. However, those having ordinary skill in the art will appreciate that the beam 56 illustrated herein may include a varying thickness and/or width without departing from the scope of the present invention. By way of example, the width and/or thickness of the beam 56 may taper linearly from the beam center, sinusoidally, parabolically, or asymmetrically. Additionally, the beam 56 is illustrated in the figures as a single, integral piece of material such that it defines a consolidated cross-section. However, those having ordinary skill in the art will appreciate that the beam 56 may be formed into a single piece by a plurality of laminates.

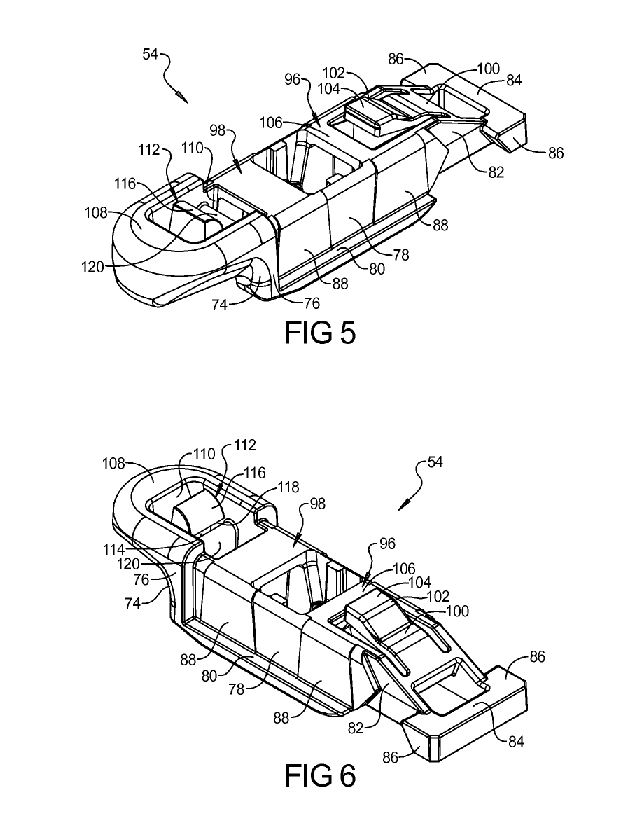

Referring to FIGS. 2 and 5 through 11, the wiper assembly 26 further includes a wiper coupler adaptor, generally indicated at 54, that is operatively mounted to the wiper coupler 53 of the wiper assembly 26 and is employed for connection to the attachment member 34 of the wiper arm 24. As illustrated in one embodiment, the wiper coupler adaptor 54 includes a pair of sidewalls 74. Each of the sidewalls 74 defines a surface 76 disposed generally opposed relative to the other. The opposed surfaces 76 include a recessed section 78 adapted to operatively engage the rails 42 of the attachment member 34. The recessed section 78 is partially defined within the opposed surfaces 76 by a lip 80 that is adapted to provide a positive stop with respect to the rails 42 of the attachment member 34 when the wiper assembly 26 is attached to the wiper arm 24.

Each recessed section 78 is further defined by a flange 82 that extends longitudinally outward beyond the lip 80 to provide releasable engagement with the attachment member 34. The wiper coupler adaptor 54 also includes a lock bridge 84 extending between the flanges 82. The lock bridge 84 extends laterally outward past the flanges 82 and has ends 86 adapted to engage the trailing edge 50 of the guides 46 and thereby facilitate the releasable engagement between the flange 82 and the guides 46 of the attachment member 34. The recessed section 78 further includes at least one raised fa [symbol] ade 88 to provide an interference fit between the wiper coupler adaptor 54 and the rails 42 of the attachment member 34. Those having ordinary skill in the art will appreciate that the raised fa [symbol] ade 88 also provides additional support to the sidewalls 74 and that the recessed section 78 may include more than one raised fa [symbol] ade 88.

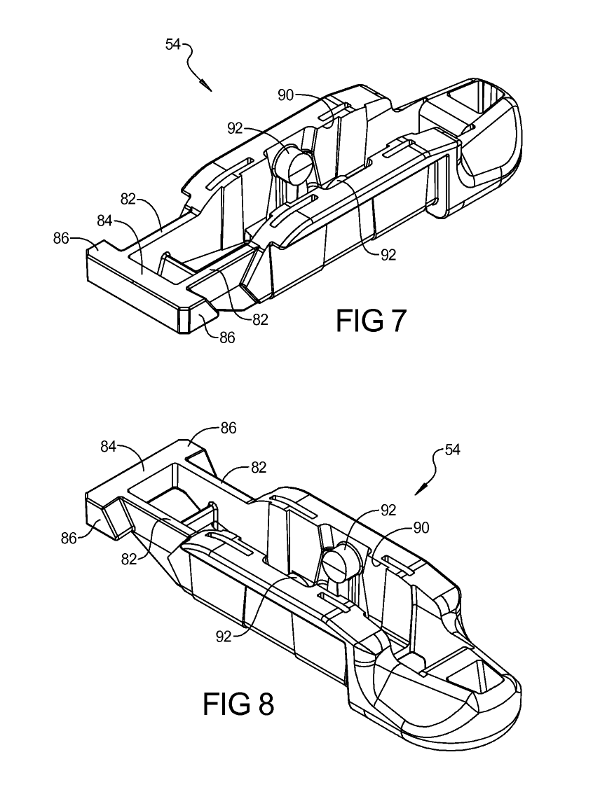

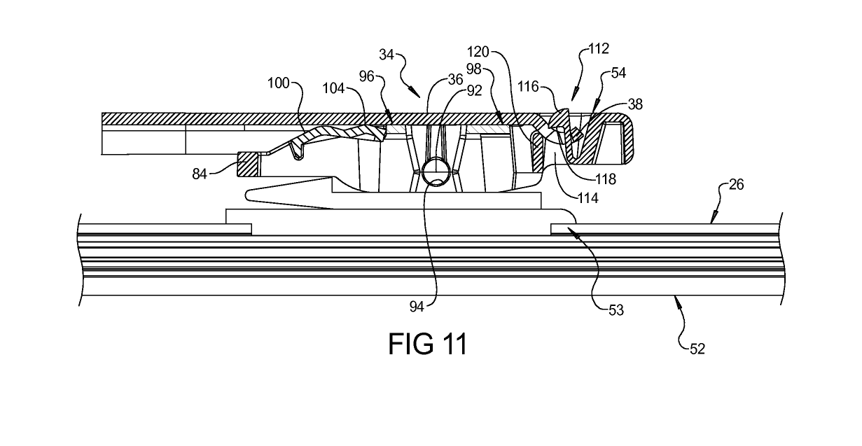

As illustrated in FIGS. 7 and 8, each of the sidewalls 74 further includes an inward surface 90 facing each other. The inward surfaces 90 include posts 92 that extend transversely or laterally from their respective inward surface 90 and toward each other. The posts 92 operatively engage aligned bores 94 (FIG. 11) of the wiper coupler 53 and provide a bearing surface about which the wiper coupler adaptor 54 and wiper coupler 53 may pivot relative to each other.

Referring to FIGS. 5 through 10, the wiper coupler adaptor 54 further includes a deck, generally indicated at 96, disposed between the sidewalls 74. The deck 96 cooperates with the recessed sections 78 of the sidewalls 74 to define a rest, generally indicated at 98, that is adapted to operatively receive the track 44 of the attachment member 34. The deck 96 includes a cantilevered beam 100 that is disposed between the flanges 82 to define a distal end 102 of the deck 96. The cantilevered beam 100 includes a raised portion or retention tab 104 that is adapted to provide an interference fit against the track 44 of the attachment member 34, such that the cantilevered beam 100 is entirely disposed within the track 44 when the wiper coupler adaptor 54 is operatively attached to the wiper arm 24.

The deck 96 further includes a bridge 106 disposed between the sidewalls 74. The bridge 106 provides a stop to prevent undesired disconnect between the wiper arm 24 and the wiper coupler adaptor 54. More specifically, should the lock bridge 84 unintentionally disengage from the guides 46, the bridge 106 will stop the linear movement of the bent tab 38 relative to the wiper coupler adaptor 54, so as to prevent the wiper arm 24 from separating from the wiper assembly 26. Those having ordinary skill in the art will appreciate that the bridge 106 further provides structural support between the sidewalls 74.

As illustrated in FIGS. 5, 6, 9, and 10, the wiper coupler adaptor 54 includes an elevated platform 108 disposed between the sidewalls 74 that cooperates with the sidewalls 74 and the bridge 106 to define an aperture 110 therebetween. Those having ordinary skill in the art will appreciate that the elevated platform 108 additionally provides structural support between the sidewalls 74. The wiper coupler adaptor 54 further includes an engaging member or snap bridge, generally indicated at 112, that is disposed within the aperture 110. The snap bridge 112 depends from the elevated platform 108 and includes a cantilevered body 114 and a head 116 disposed at the terminal end of the cantilevered body 114. The head 116 also includes a lip 118 depending therefrom. The lip 118 is adapted to receive a portion of the bent tab 38 to prevent undesired release of the wiper coupler adaptor 54 from the attachment member 34. More specifically, the lip 118 provides an interference fit between a portion of the bent tab 38 and the snap bridge 112.

The wiper coupler adaptor 54 further includes a rib 120 to protect the adaptor against mis-assembly with the bent tab 38 of the attachment member 34. The rib 120 is disposed in the aperture 110 and extends from at least one of the sidewalls 74. In the embodiment illustrated, the rib 120 extends laterally between the sidewalls 72 and is disposed below the head 116 of the snap bridge 112 and spaced longitudinally from the snap bridge 112. The rib 120 is generally rectangular in shape, but may be any suitable shape. It should be appreciated that the rib 120 will not allow the bent tab 38 to fully seat if mis-assembled.

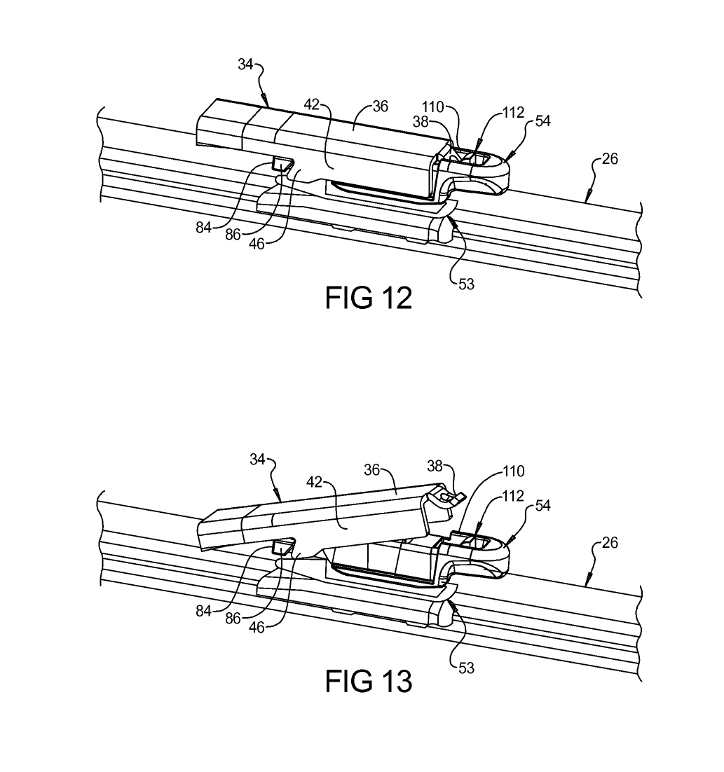

In operation, FIGS. 11 through 13 illustrate the attachment of the wiper assembly 26 to the wiper arm 24. As illustrated in FIG. 11, the wiper coupler adaptor 54 is properly assembled when the wiper coupler adaptor 54 is seated adjacent the wiper coupler 53 and the aligned posts 92 operatively engage the aligned bores 94. As illustrated in FIG. 13, the embodiment of the wiper assembly 26 is properly attached to the wiper arm 24 by seating the guides 46 against the lock bridge 84 and rotating the attachment member 34 toward the wiper coupler adaptor 54. As illustrated in FIG. 12, the bent tab 38 is then inserted within the aperture 110, so as to contact the lip 118, and locks the attachment member 34 in place with the wiper assembly 26. Proper attachment of the wiper assembly 26 is further achieved when the track 44 of the attachment member 34 is seated on the rest 98. The rib 120 prevents the body 114 of the snap bridge 112 from breaking off if a mis-assembly force is used because the head 116 would contact the rib 120. It should be appreciated that, if the bent tab 38 is fully seated and mis-assembled, the snap bridge 112 would break but for the rib 120. It should also be appreciated that a full solid rib for the rib 120 is optional.

Accordingly, replacement of the wiper assembly 26 of the present invention illustrated in FIGS. 12 and 13 is accomplished by applying force to the head 116 in a direction toward the elevated platform 108, thereby disengaging the bent tab 38 from contact with the lip 118 and rotating the wiper assembly 26 such that the elevated platform 108 moves away from the bent tab 38. Removal of the wiper assembly 26 from the wiper arm 24 is achieved when the lock bridge 84 disengages from the trailing edge 50 of the guides 46.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A wiper coupler adaptor for releasably attaching a wiper assembly to a wiper arm, said wiper coupler adaptor comprising:
a pair of sidewalls extending longitudinally and each including a post that extends laterally toward the other and adapted to operatively engage a wiper assembly, said sidewalls including recessed sections adapted to operatively engage rails of an attachment member of a wiper arm
a deck disposed between said sidewalls to define a rest that is adapted to operatively receive a track between the rails of the attachment member;
an elevated platform disposed between said sidewalls that cooperates with said sidewalls and said deck to define an aperture adapted to receive a portion of a bent tab of the attachment member;
a snap bridge disposed within said aperture and depending from said elevated platform and including a cantilevered body and a head disposed at a terminal end of said cantilevered body, said head including a lip depending therefrom that is adapted to receive a portion of the bent tab of the attachment member to prevent undesired release of said wiper coupler adaptor from the attachment member; and
a rib disposed within said aperture and extending from at least one of said sidewalls to prevent said snap bridge from breakage by the bent tab of the attachment member if mis-assembled.

2. A wiper coupler adaptor as set forth in claim 1 wherein said rib extends from said sidewalls across said aperture.

3. A wiper coupler adaptor as set forth in claim 1 wherein said rib is disposed below said head of said snap bridge.

4. A wiper coupler adaptor as set forth in claim 1 wherein said rib is spaced longitudinally from said snap bridge.

5. A wiper coupler adaptor as set forth in claim 1 wherein said rib is disposed in said aperture between said snap bridge and said deck.

6. A wiper coupler adaptor for releasably attaching a wiper assembly to a wiper arm, said wiper coupler adaptor comprising:
a pair of sidewalls extending longitudinally and each including a post that extends laterally toward the other and adapted to operatively engage a wiper assembly, said sidewalls including recessed sections adapted to operatively engage rails of an attachment member of a wiper arm
a deck disposed between said sidewalls to define a rest that is adapted to operatively receive a track between the rails of the attachment member;
an elevated platform disposed between said sidewalls that cooperates with said sidewalls and said deck to define an aperture adapted to receive a portion of a bent tab of the attachment member;
a snap bridge disposed within said aperture and depending from said elevated platform and including a cantilevered body and a head disposed at a terminal end of said cantilevered body, said head including a lip depending therefrom that is adapted to receive a portion of the bent tab of the attachment member to prevent undesired release of said wiper coupler adaptor from the attachment member; and
a rib disposed within said aperture between said snap bridge and said deck and below said head of said snap bridge and extending from between said sidewalls across said aperture to prevent said snap bridge from breakage by the bent tab of the attachment member if mis-assembled.

7. A wiper assembly for use in connection with a wiper arm having an attachment member, said wiper assembly comprising:
a wiping element adapted to contact a surface to be wiped;
a structure operatively engaging said wiping element;
a wiper coupler operatively mounted to said structure; and
a wiper coupler adaptor operatively mounted to said wiper coupler and the attachment member that is adapted to releasably attach said wiper coupler to the attachment member, said wiper coupler adaptor including a pair of sidewalls extending longitudinally and each including a post that extends laterally toward the other and adapted to operatively engage a wiper assembly, said sidewalls including recessed sections adapted to operatively engage rails of an attachment member of a wiper arm, a deck disposed between said sidewalls to define a rest that is adapted to operatively receive a track between the rails of the attachment member, an elevated platform disposed between said sidewalls that cooperates with said sidewalls and said deck to define an aperture adapted to receive a portion of a bent tab of the attachment member, a snap bridge disposed within said aperture and depending from said elevated platform and including a cantilevered body and a head disposed at a terminal end of said cantilevered body, said head including a lip depending therefrom that is adapted to receive a portion of the bent tab of the attachment member to prevent undesired release of said wiper coupler adaptor from the attachment member, and a rib disposed within said aperture and extending from at least one of said sidewalls to prevent said snap bridge from breakage by the bent tab of the attachment member if mis-assembled.

8. A wiper assembly as set forth in claim 7 wherein said rib extends from said sidewalls across said aperture.

9. A wiper assembly as set forth in claim 7 wherein said rib is disposed below said head of said snap bridge.

10. A wiper assembly as set forth in claim 7 wherein said rib is spaced longitudinally from said snap bridge.

11. A wiper assembly as set forth in claim 7 wherein said rib is disposed in said aperture between said snap bridge and said deck.
